(19) United States
(12) Patent Application Publication
(10) Pub. No.: US 2009/0024707 A1
(43) Pub. Date: Jan. 22, 2009

(54) Electronic Messaging System and Method For A Vehicle

(75) Inventors: Jan H. Aase, Oakland Township, MI (US); Joseph F. Mercurio, Birmingham, MI (US); Jocelyn J. Lau, Bloomfield Hills, MI (US); In Woong Lee, Rochester Hills, MI (US); Russell Lewis Ernest Blanchard, London (GB)

Correspondence Address: Quinn Law Group, PLLC, 39555 Orchard Hill Place, Suite 520, Novi, MI, 48375, US

(73) Assignee: GM GLOBAL TECHNOLOGY OPERATIONS, INC., Detroit, MI (US)

(21) Appl. No.: 12/131,172

(22) Filed: Jun. 2, 2008

Related U.S. Application Data
(60) Provisional application No. 60/950,493, filed on Jul. 18, 2007.
(60) Provisional application No. 60/950,485, filed on Jul. 18, 2007.

(51) Int. Cl. G06F 15/16; G10L 15/26; G10L 13/08

(52) U.S. Cl. 709/206; 704/235; 704/260

(57) ABSTRACT

A vehicle includes a body defining a passenger compartment and a messaging system having a user input device with a display. The input device receives an outgoing communication from an occupant and presents the outgoing communication on the display. The messaging system generates an outgoing e-mail message describing the outgoing communication, and containing a text file corresponding to a speech message and/or a digital image file describing a handwritten trace message, and transmits the outgoing e-mail message to a remote source. A method for exchanging electronic messages between a vehicle and a remote source includes recording an outgoing message using a user input device, generating an outgoing e-mail message by recording a voice message as a first electronic audio or text file and/or recording a handwritten trace of as a second electronic image file, and transmitting the e-mail message to the remote source.

### CROSS-REFERENCE TO RELATED APPLICATIONS

This application claims the benefit of and priority to U.S. Provisional Applications 60/950,493 and 60/950,485, each filed on Jul. 18, 2007 and which are hereby incorporated by reference in their entireties.

### TECHNICAL FIELD

The present invention relates to an electronic messaging system and method for use with a vehicle in communicating with a remote source.

### BACKGROUND OF THE INVENTION

As people spend more time in their vehicles, whether commuting to and from work, traveling, or running errands, there is a perceived need to remain in touch with or “connected” to other people or other sources of information. The evolution of cell phone technology, as well as improved cell tower accessibility or network coverage, has enabled mobile users to place and receive phone calls more seamlessly than was possible in the past. However, exchanging information with a remote party or source by speaking on a telephone while traveling in a vehicle may be less than optimal under certain conditions, such as when driving in heavy traffic, while traveling with children, or under similar conditions requiring careful attention to one's surroundings. Likewise, when the other party to a voice conversation is not available to receive a phone call, a potentially inefficient exchange of voice or text messages may result.

### SUMMARY OF THE INVENTION

Accordingly, a messaging system is provided for use with a vehicle which allows a user or occupant of a vehicle to communicate with a remote source. The user can generate an outgoing electronic message which is converted into a suitable electronic format by a controller, and which is transmitted to the remote source via e-mail, with or without attachments as needed. The remote source, typically a person utilizing a mobile hand-held or desktop computing device, can respond in kind by generating and transmitting an incoming e-mail message to the occupant. Both the outgoing and the incoming messages can be displayed in text form on a display screen located within the vehicle interior, such as within an instrument panel, and if desired, can be rendered audible to the user using voice-to-text translation software. In this manner, the occupant of the vehicle can focus on other tasks while actively communicating with the remote source, with any incoming e-mail messages that are received in the vehicle being “read” via a speaker to the occupant. The occupant can then respond with a voice memo or speech message in the form of a digital file which can either be attached to the outgoing e-mail, and/or the translation software can translate the speech message into text and send the text with the e-mail.

In one embodiment, a user input device includes a display screen, which can include a touch screen portion to allow the occupant to enter handwritten notes or traces while seated in the vehicle interior. The handwritten traces are then saved or recorded as image files or converted to text, and these recorded files can be transmitted via e-mail to the remote source or vice versa as needed, and/or transferred locally via a data port and removable media to a personal computer and/or a mobile handheld device. In this manner, the need to search for a pen and paper or place a telephone call while driving is minimized.

In particular, a vehicle is provided including a body defining a passenger compartment, and also including a messaging system. The vehicle has a user input device with a display screen, with the user input device being operable for receiving an outgoing communication from an occupant positioned within the passenger compartment, and for presenting the outgoing communication to the occupant on the display screen. The messaging system generates an outgoing e-mail message describing the outgoing communication, the e-mail message containing a first text file corresponding to a first speech message from the occupant and/or a digital image file describing a handwritten trace message from the occupant. The messaging system is configured for transmitting the outgoing e-mail message to a remote source.

A method is also provided for exchanging electronic messages between a vehicle and a remote source. The method includes recording an outgoing message using the user input device, generating an outgoing e-mail message containing the outgoing message, and transmitting the outgoing e-mail message to the remote source. Recording an outgoing message includes one or both of recording a voice message of an occupant of the vehicle as a first electronic file and recording a handwritten trace of occupant as a second electronic file. When recording the handwritten trace as a digital image file, the method can include attaching the digital image file to the outgoing e-mail message.

The above features and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic illustration of a vehicle having an electronic messaging system in accordance with the invention;

FIG. 2 is a schematic illustration of a passenger compartment of the vehicle of FIG. 1;

FIG. 2A is a schematic illustration of a portion of the passenger compartment of FIG. 2 and an exemplary remote source with which the messaging system of FIG. 1 may communicate; and

FIG. 3 is a schematic illustration of another embodiment of the messaging system of FIGS. 1, 2, and 2A.

### DESCRIPTION OF THE PREFERRED EMBODIMENTS

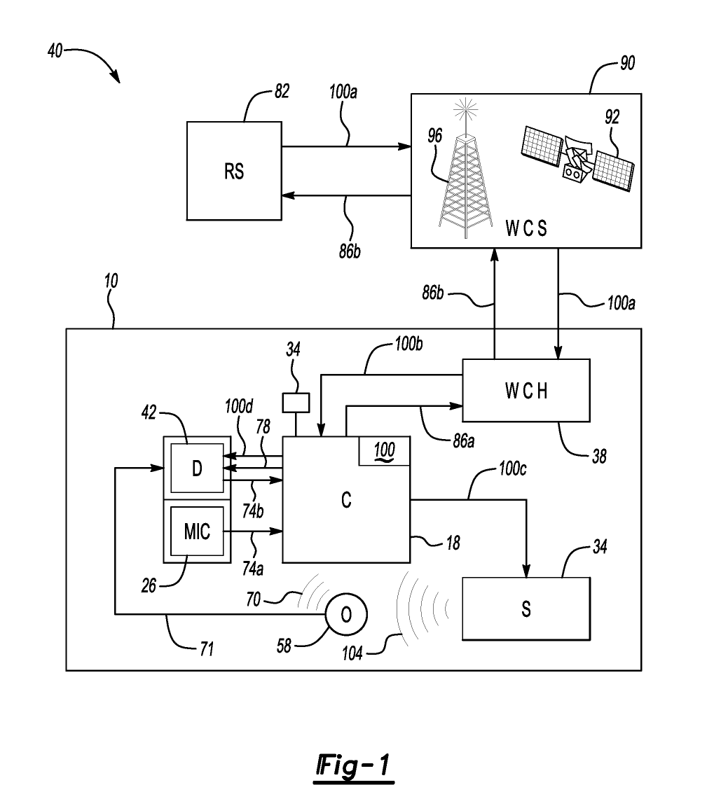

Referring to the drawings wherein like reference numbers represent like components throughout the several figures, and beginning with FIG. 1, a vehicle 10 includes an electronic communications or a messaging system 40 which is operable for sending various electronic messages from the vehicle 10 to a remote source (RS) 82, such as a server, a computing device, etc., and for receiving the same from the remote source 82. The system 40 includes an electronic control unit or controller 18 having an algorithm 99 as described below. The controller 18 can include any necessary electronic components, including but not limited to a microprocessor, a data storage medium, and any appropriate input and output circuitry of a known type for receiving various input signals and for transmitting various output signals. The controller 18 may be dedicated to the system 40, or it may be an integrated unit which is part of another system or systems of the vehicle 10. For example, the controller 18 may be a body control module that controls the system 40 and other vehicle body systems (not shown).

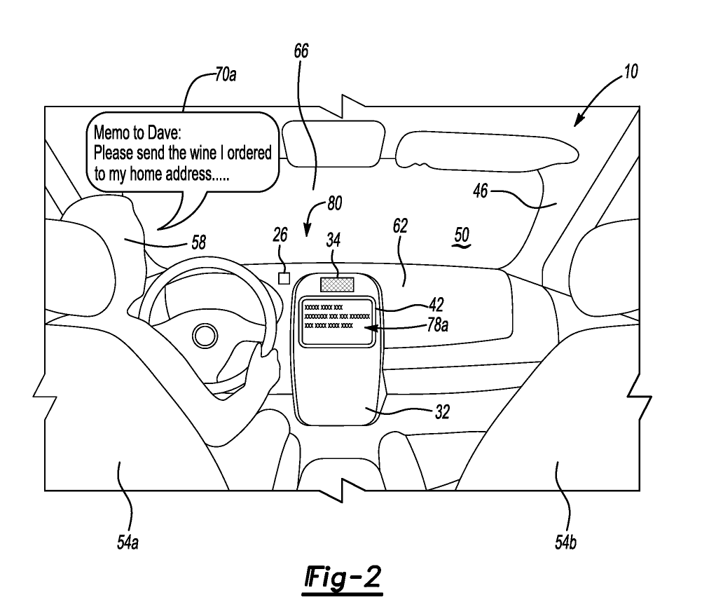

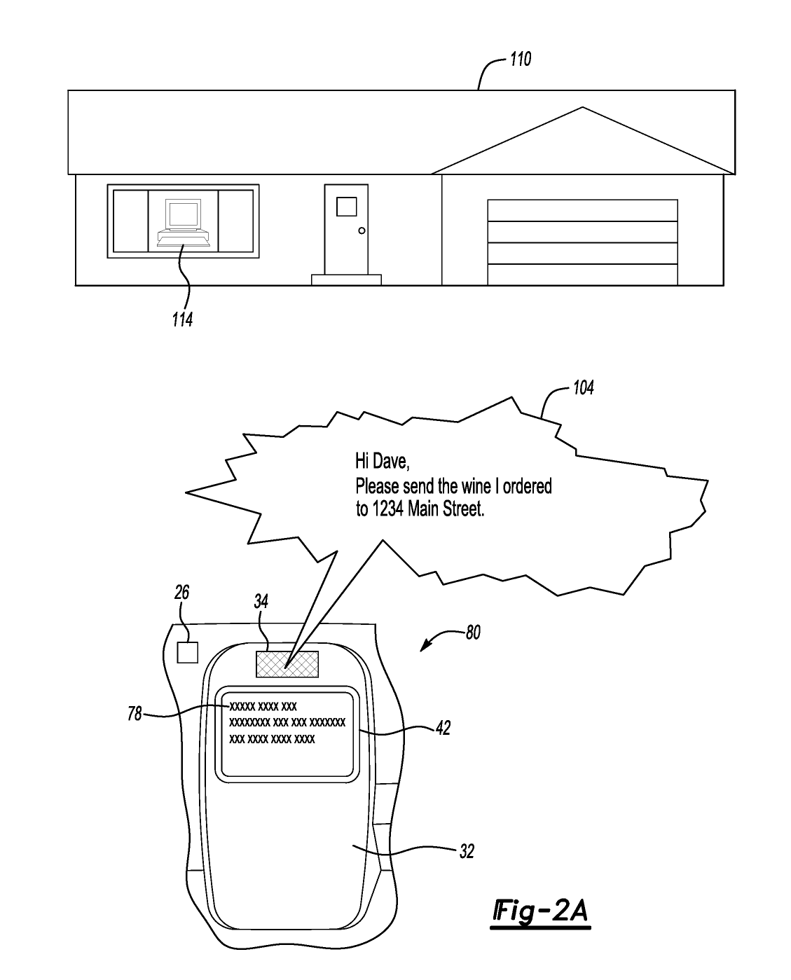

The system 40 includes a user input device 80, which includes a display (D) 42 and a microphone (MIC) 26, each of which is electrically connected to and controllable by the controller (C) 18. The microphone 26 is configured for receiving an articulated or spoken speech message by an occupant (O) of the vehicle 10, and for generating various signals or waveforms indicative or representative of the sound waves 70 defining the speech message. The microphone 26 is also configured for transmitting the signals to the controller 18. The system 40 further includes one or more audio speakers 34 that are operatively connected to the controller 18. The system 40 also includes wireless connectivity hardware (WCH) 38, such as but not limited to a communication transmitter and receiver that are operatively connected to the controller 18. The display 42 (also see FIGS. 2 and 2A) is a touch-screen device of the type known in the art, i.e., is a liquid crystal display device or other suitable device that is operable for touch-screen activation. The display 42 is therefore operable for conveying electronic messages in text form, i.e., visual information, to and from the occupant 58, as will be described later hereinbelow.

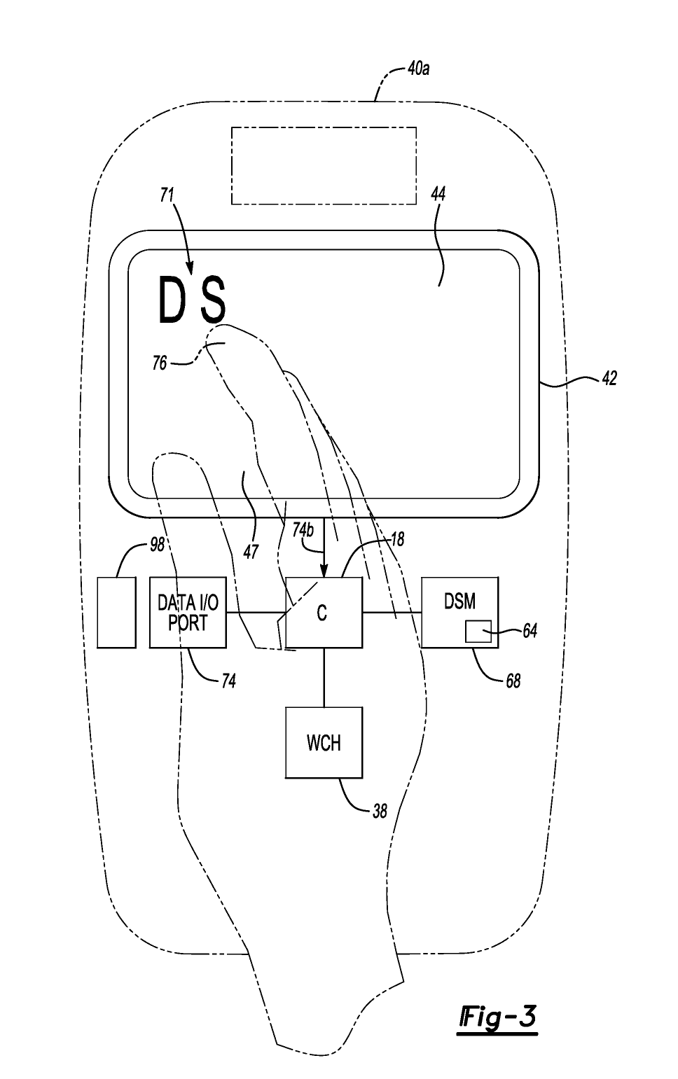

The system 40 is configured for recording, transmitting, and receiving various electronic messages, including both audio (spoken) and textual (typed or handwritten) messages, to and from the remote source 82 or locally within the vehicle 10 via electronic mail or e-mail. Therefore, the microphone 26 is sufficiently positioned for receiving the sound waves 70 generated by the occupant 58 when the occupant 58 is speaking, dictating, or otherwise articulating an audio or speech message, such as in a center console 32 (see FIGS. 2 and 2A) or other suitable location within the vehicle 10. The microphone 26 is also operable for converting the sound waves 70 into a suitable electronic signal 74a that includes any necessary data corresponding to and adequately defining or describing the informational content of the sound waves 70. Likewise, the display 42 (see FIGS. 2 and 2A) is sufficiently positioned for receiving any handwritten messages or traces 71 (also see FIG. 3), and for converting the traces 71 into an electronic signal 74b that includes any necessary data corresponding to and defining or describing the traces 71. In this manner, the system 40 can receive and transmit messages in either or both of an audio and a textual format.

Still referring to FIG. 1, the controller 18 is programmed to record data corresponding to the sound waves 70 and to the traces 71 in a suitable electronic format such as a digital file, i.e., any electronic format that is appropriate for the respective sound waves 70 or traces 71. For example, the sound waves 70 can be recorded in Waveform Audio Format (WAV), an Audio Interchange File Format (AIFF), an MPEG-1 Audio Layer 3 (MP3) format, etc. In one embodiment, the controller 18 is programmed with or has access to a speech recognition algorithm 99, whereby the controller 18 converts the speech of the occupant 58 as represented by the sound waves 70 into a text message, which can then be transmitted via e-mail to the remote source 82 or locally within the vehicle 10, such as might be desired when downloading the message to a hand-held or laptop computing device.

More specifically, the controller 18 can be programmed to convert the information communicated by the microphone 26 as the signal 74a to a text-based format that corresponds to the information content of the sound waves 70, as will be explained below with reference to FIGS. 2 and 2A. Likewise, the controller 18 can be programmed to convert the textual information entered into the display 42 of FIGS. 2 and 2A as the signal 74b. Depending on the particular application, the controller 18 can use the algorithm 99 to convert the signals 74a and/or 74b to a text signal 78 and cause the display 42 to present or display the text that corresponds to the speech conveyed via the sound waves 70, as shown in FIG. 2. The operator 58 can then verify the accuracy of the translation before proceeding with the transmission of the message to the remote source 82.

The system 40 receives e-mail messages from the remote source 82 such as an off-board computing device or a remote server such as an internet server. More specifically, the controller 18 transmits an electronic signal 86a carrying data that includes an electronic mail message and any attached audio file to the WCH 38, which converts the signal 86a to an RF signal 86b and transmits the signal 86b to a wireless communication system (WCS) 90. The WCS 90 relays the signal 86b to the remote source 82, which then routes the electronic mail message and audio files to the intended recipient as needed. The WCS 90 may typically include, for example, a satellite relay 92, a cellular telephone system 96, etc.

In turn, the remote source 82 transmits an electronic or RF signal 100a to the WCS 90. The signal 100a includes data corresponding to another e-mail message, which includes text. The WCS 90 relays the signal 100a to the WCH 38 within the vehicle 10. The WCH 38 then converts the signal 100a to an electronic signal 100b that includes the data corresponding to the inbound e-mail message, and transmits the signal 100b to the controller 18. The controller 18 is programmed to process the signal 100b using the algorithm 99, which is as noted above is a text-to-speech algorithm of the type known in the art, in order to generate the electronic signal 100c.

The signal 100c is transmitted by the controller 18 to the speaker 34, and is configured to cause the speaker 34 to produce sound waves 104 which are audible by the occupant 58, and which are understandable as human speech corresponding to the text of the second electronic mail message. Thus, the system 40 selectively “reads” the textual content of the second electronic mail message received from the server 82 to the occupant 58. That is, the system 40 can be optionally adapted for selectively turning on and off the voice translation of the second electronic message, should the occupant 58 only wish to view the text itself and not hear the content of the message, or vice versa. The controller 18 may also transmit control signals 100d to the display 42. The control signals 100d cause the display 42 to reproduce the text (and any other content such as graphics) of the second electronic mail message on the display 42 such that the text is clearly visible to the occupant 58.

Referring to FIGS. 2 and 2A, the vehicle 10 of FIG. 1 includes a vehicle body 46 that defines a vehicle interior or a passenger compartment 50. The body 46 includes a driver seat 54a and a front passenger seat 54b for supporting one or more occupants 58 within the passenger compartment 50. An instrument panel 62 defines part of the forward end of the passenger compartment 50 adjacent to a windshield 66. In the embodiment depicted in FIGS. 2 and 2A, the microphone 26 is mounted to or within the instrument panel 62 such as in or near a center console 32 to receive any command or messages communicated via the sound waves 70 from the occupant 58. Likewise, the speaker 34 is mounted to or within the instrument panel 62 to selectively generate sound waves 104 within the passenger compartment 50, and the display 42 is sufficiently mounted to or within the instrument panel 62 to present the signal 78 as text which is clearly visible by the occupant 58. However, those skilled in the art will recognize that other suitable locations may be used within the vehicle passenger compartment 50 within the scope of the invention for the microphone 26, the speaker 34, and the display 42, such as a headliner, a sun visor, etc.

The controller 18 is also configured to synchronize or link with the remote source 82 (see FIG. 1), embodied in FIG. 2A as the computing device 114, which is located remotely from the vehicle 10 such as within a building 110. For example, e-mail messages may be transmitted to the computing device 114 using the WCH 38 and the WCS 90, or using a wireless local area network or any other wireless communication technology such as Bluetooth. Thus, the occupant 58 can articulate a phrase 70a as shown in FIG. 2, which corresponds to the sound waves 70 of FIG. 1. This phrase 70a shows up as a text message 78a in the display screen 42. The algorithm 99 (see FIG. 1) can translate the initial text message 78a into speech so that the operator 58 does not have to divert attention to the display 42 while driving. If the initial text message 78a is acceptable, the operator 58 can transmit a final text message 78, as shown in FIG. 2A. Although not required, the final text message 78 may vary from the initial text message 78a as the algorithm 99 automatically replaces general terms such as “my home address” with a particular address matching this recognized phrase, or by replacing general instructions such as “memo to Dave” with a preselected personal greeting such as “Hi Dave”.

Referring to FIG. 3, another embodiment 40a of the system 40 of FIG. 1 includes the display 42, which functions as a touch-screen interface between the occupant 58 (see FIGS. 1 and 2) and the controller 18. The display 42 functions as an output device by displaying visual information from the controller 18. The display 42 also functions as an input device, whereby the occupant 58 can input information to the controller 18 by touching a touch screen portion 44 to form a trace 71, as will be understood by those skilled in the art. The handwritten text message signal 74b is communicated to the controller 18 from the display 42. In this manner, the controller 18 operates in a note-recording mode.

In the note-recording mode, occupant 58 (see FIG. 2) touches the touch screen portion 44 of the display 42 with a fingertip 76. When the note-recording mode is initiated, the controller 18 causes a region 47 of the touch screen portion 44 to be presented in a first color. The region 47 may be the entire touch screen portion 44 or only a portion thereof. The display 42 communicates to the controller 18 any point of contact between the fingertip 76 and the touch screen portion 44. In response, once a point within the region 47 has been contacted by the fingertip 76, the controller 18 causes the point to change from the first color to a second color which is different from the first color, i.e., sufficiently different so as to provide contrast. The points within the region 47 that have not been contacted by the fingertip 76 after the initiation of the note-taking mode remain presented in the first color. Accordingly, the points within the region 47 that have been contacted by the fingertip 76 and that have been changed to the second color thus sufficiently contrast with the first color to define a trace 71. The trace 71 is a visible image, and may include but is not limited to various alphanumeric characters, sketches, figures, etc.

The controller 18 retains all of the points of contact between the fingertip 76 and the region 47 of the touch screen portion 44 in memory. The controller 18 is configured such that, when the occupant 58 (see FIG. 2) indicates to the controller 18 that the desired trace 71 is complete, the controller 18 stores the trace 71 as a digital image file 64 in a data storage medium (DSM) 68 that is operatively connected to the controller 18. Those skilled in the art will recognize a variety of digital image file formats for the digital image file 64, such as the Joint Photographic Experts Group (JPEG) format, the Tagged Image File Format (TIFF), the Graphic Interchange Format (GIF), etc. Those skilled in the art will also recognize a variety of data storage modules 68 that may be employed within the scope of the claimed invention, such as random access memory (RAM), writable ROM, etc. The note-taking mode may be re-initiated upon the command of the occupant to the controller 18, after which the controller 18 causes all of region 47 to become the first color.

The controller 18 can also be connected to a data port 74. The data port 74 is configured to read and write data to a removable data storage medium 68. Thus, in the event that the vehicle 10 (see FIGS. 1 and 2) is not close enough to a remote source 82 (see FIG. 1) to establish a wireless connection therewith, the occupant 58 of FIG. 2 can command the controller 18 to store the file 64, or any other file stored in module 68, on the removable data storage medium 98. Accordingly, the occupant 58 of FIG. 2 may then remove the data storage medium 98 from data port 74 and transport the storage medium 98 with the file 64 thereon to another device. Those skilled in the art will recognize a variety of data ports that read and write to a removable storage medium and that may be employed within the scope of the claimed invention. In an exemplary embodiment, the data port 74 is a Universal Serial Bus (USB) port, and removable data storage medium 98 is USB flash drive.

Once the wireless connection is established between the controller 18 and the remote source 82 (see FIG. 1), such as the personal computer 114 of FIG. 2A, the controller 18 synchronizes the controller 18 with the remote source 82, as understood by those skilled in the art. Thus, the controller 18 can then transmit the data file 64, and other data files that have been created or modified by the occupant 58 of the passenger compartment 50 and stored on storage module 68, for example to the personal computer 114 of FIG. 2A. Similarly, the controller 18 can cause the personal computer 114 of FIG. 2A to transmit files stored thereon to the controller 18, which can then store the files received from the personal computer 114 in the data storage module 68. For example, if the personal computer 114 has routing information to a destination stored thereon, the personal computer 114 can transmit the routing information to the controller 18 via the wireless connection. The routing information can then be accessed by an occupant 58 (see FIG. 2) of the passenger compartment 50 via the display 42. The personal computer 114 is exemplary; other devices with which controller 18 can establish wireless connectivity via the WCH 38 include laptop computers, handheld computers, cellular telephones, etc.

While the best modes for carrying out the invention have been described in detail, those familiar with the art to which this invention relates will recognize various alternative designs and embodiments for practicing the invention within the scope of the appended claims.

1. A vehicle comprising:
a body defining a passenger compartment; and
a messaging system having a user input device, the user input device including a display that is operable for receiving an outgoing communication from an occupant positioned within the passenger compartment and for presenting the outgoing communication to the occupant;
wherein the messaging system is configured for generating an outgoing electronic mail (e-mail) message describing the outgoing communication, the outgoing e-mail message containing at least one of a first text file corresponding to a first speech message from the occupant and a digital image file describing a handwritten trace message from the occupant;
and wherein the messaging system is configured for transmitting the outgoing e-mail message to a remote source.

2. The vehicle of claim 1 further comprising a speaker;
wherein the messaging system is operable for receiving an incoming e-mail message from the remote source, the incoming e-mail message including a second text file; and
wherein the messaging system is operable for presenting the second text file to the user on a surface of the display, and for selectively translating the second text file into a second speech message for communication to the user via the speaker.

3. The vehicle of claim 1 further comprising a speaker;
wherein the messaging system is operable for translating the first text file into a speech message, and for communicating the speech message to the occupant via the speaker.

4. The vehicle of claim 1, further comprising a data port which is operable for reading and writing each of the first text file and the second text file to a removable data storage medium.

5. The vehicle of claim 1, wherein the display includes a touch screen portion which is operable for capturing the handwritten trace message defining the outgoing communication from the occupant, and for converting the handwritten trace message into the digital image file.

6. A messaging system for a vehicle, the system comprising:
a user input device having a touch-screen and a microphone; a
a set of wireless connectivity hardware (WCH); and
a controller in communication with the set of WCH for exchanging electronic mail (e-mail) messages with a remote source;
wherein the controller is operable for receiving an incoming electronic mail (e-mail) message containing a first text message from the remote source, for displaying the first text message on the touch screen, for selectively translating the first text message into speech which is audible by an occupant positioned within the vehicle, and for transmitting an outgoing electronic message to the remote source in the form of a second e-mail message.

7. The messaging system of claim 6, wherein the controller is further operable for recording as the digital message at least one of a speech message and a handwritten message of the occupant, and for presenting the digital message as one of a text message and a digital image on the touch screen.

8. The messaging system of claim 6, wherein the digital message is an image file having a format selected from the group consisting of: Joint Photographic Experts Group (JPEG) format, Tagged Image File Format (TIFF), and Graphic Interchange Format (GIF) format.

9. The system of claim 6, further comprising a data port which is operable for reading and writing the digital message to a removable data storage medium.

10. The messaging system of claim 6, wherein the controller is operable for translating the speech of the occupant as a second text file, and for transmitting the second text file as the digital message to the remote source.

11. The messaging system of claim 10, wherein the system is operable for replaying the speech to the occupant prior to transmitting the second text file to thereby allow the occupant to modify the second text file.

12. A method for exchanging electronic messages between a vehicle having a user input device and a remote source, the method comprising:
recording an outgoing message using the user input device;
generating an outgoing electronic mail (e-mail) message containing the outgoing message; and
transmitting the outgoing e-mail message to the remote source;
wherein recording an outgoing message includes at least one of recording a voice message of an occupant of the vehicle as a first electronic file and recording a handwritten trace generated by the occupant as a second electronic file.

13. The method of claim 12, further comprising automatically translating the voice message of the occupant into a text file;
wherein generating an outgoing e-mail message includes providing the text file within the outgoing e-mail message.

14. The method of claim 12, wherein recording an outgoing message includes recording the handwritten trace as a digital image file; and
wherein generating an outgoing e-mail message includes attaching the digital image file to the outgoing e-mail message.

15. The method of claim 12, further receiving an incoming e-mail having a text message from the remote source, translating the text message into a voice message, and rendering the voice message audible to the occupant within the vehicle.
